(19) United States
(12) Patent Application Publication
(10) Pub. No.: US 2011/0288934 A1
(43) Pub. Date: Nov. 24, 2011

(54) AD STALKING DEFENSE

(75) Inventors: John R. Douceur, Bellevue, WA (US); Jacob R. Lorch, Bellevue, WA (US); James Mickens, Bellevue, WA (US); Thomas Moscibroda, Redmond, WA (US); David Levin, College Park, MD (US)

(73) Assignee: MICROSOFT CORPORATION, Redmond, WA (US)

(21) Appl. No.: 12/786,231

(22) Filed: May 24, 2010

(51) Int. Cl. G06Q 30/00; G06F 17/30; G06F 3/048

(52) U.S. Cl. 705/14.53; 705/14.66; 705/14.49; 707/769; 715/760; 707/705; 707/E17.014

(57) ABSTRACT

Techniques are described to mitigate ad stalking and other user concerns resulting from user-targeted advertising. A user may be informed of advertising information by a process in which an advertising server receives a request for an ad. The request may have been generated in response to a user request for a landing web page. An ad may be selected based on user information available to the advertising server, where the user information is associated with the user and describes behavior and/or attributes and/or preferences associated with the user. Text about how the ad was selected may be incorporated into the ad. Such text may describe the user information used to select the ad. The selection-disclosing text may be incorporated in the ad in a form that is displayable to the user by a browser. The ad may then be transmitted for display in the landing web page.

### BACKGROUND

Online advertising has become increasingly sophisticated. Ads embedded in web pages, HTML documents, emails, etc. are selected by processes that may take into consideration attributes, behaviors, and personal information about users. While the technical methods for doing so vary significantly, the general approach, often referred to as behavioral (or targeted) advertising, involves matching ads to users. This approach helps advertisers achieve increasingly sophisticated ad targeting, motivating ad service providers to provide such services. To this end, advertisers are basing ad placements on increasingly private information, such as the contents of a user's e-mail, a user's web activity, and so on. This personalization of on-line advertisements, and the resulting desire for private information, is likely to increase in the future.

While delivery of information (in the form of an ad) that is likely to be of interest to a user may be beneficial, such detailed targeting can lead to problems such as ad stalking, disclosure of private or personally identifiably information, or linking of personal information to particular individuals. Ad stalking refers to the crafting of an advertising campaign with the purpose of locating or tracking a specific individual or a small set of individuals having in common a single characteristic which is uncommon, or having in common a set of characteristics that, when considered in aggregate, are uncommon. The stalker may accomplish this by crafting an advertising campaign that targets a very narrow audience: for example, the set consisting solely of the single victim the stalker intends to stalk. Such an ad may be targeted to user attributes that in combination closely match the target user and few, if any, other users. When the stalking target or victim clicks or activates an ad selected by such a carefully tailored ad campaign, the stalker can locate and track the victim. For instance, the stalker can locate the victim by geo-locating the IP address where the click occurred. He can further track the victim by installing a cookie or exploiting a browser vulnerability. In other cases, the mere existence of a user who clicks on an ad might reveal privacy-compromising data. Consider an ad targeted to all users having a given name and matching certain criteria. If some user clicks on this add, the ad stalker will know the name of the person meeting the criteria. In this case, merely interacting with an ad can be a problem.

Techniques related to mitigating ad stalking and other concerns related to behavioral-type ad targeting are discussed below.

### SUMMARY

The following summary is included only to introduce some concepts discussed in the Detailed Description below. This summary is not comprehensive and is not intended to delineate the scope of the claimed subject matter, which is set forth by the claims presented at the end.

Techniques are described to mitigate ad stalking and other user concerns resulting from user-targeted advertising. A user may be informed of advertising information by a process in which an advertising server receives a request for an ad. The request may have been generated in response to a user request for a landing web page. An ad may be selected based on user information available to the advertising server, where the user information is associated with the user and describes behavior and/or attributes and/or preferences associated with the user. Text about how the ad was selected may be incorporated into the ad. Such text may describe the user information used to select the ad. The selection-disclosing text may be incorporated in the ad in a form that is displayable to the user by a browser. The ad may then be transmitted for display in the landing web page.

Many of the attendant features will be explained below with reference to the following detailed description considered in connection with the accompanying drawings.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows a process describing generally how ads may be served to web browsers.

FIG. 2 shows an example ad distribution system.

FIG. 3 shows a process by which a user may be provided with information about how an ad was targeted to the user.

FIG. 4 shows an example of displaying ad selection information.

FIG. 5 shows an embodiment involving local ad selection.

FIG. 6 shows an embodiment in which a web page is used to apprise a user.

### DETAILED DESCRIPTION

As will be described below in detail, some downsides of behavioral advertising may be mitigated by informing users about how they are being targeted (i.e., by disclosing what information was used to select the specific ad shown, and hence, what information would be and perhaps providing information and opportunity to avoid disclosing information that may permit stalking or other undesirable potential uses of user-targeted advertising.

In one embodiment, a user may be informed about what information the user may reveal if the user were to click or activate an ad, thus allowing the user to decide whether the information is too specific or revealing or otherwise of concern if exposed or associated with the user. One technique that accomplishes this is to fashion an ad (or page containing the ad) such that a browser displaying the ad will render a tooltip or other information-display when the user hovers his cursor over the ad or otherwise interacts with the ad. While many techniques for displaying information may be used, for instance pop-up dialogs, special web pages, etc., the tooltip example will be referred to for the purpose of discussion. The ad is crafted such that the tooltip apprises the user about the possibility of disclosing information that may concern the user. For example, the tooltip may display what information associated with the user was used (by an ad selection system or ad network) to target the user with the ad, and thus what will be revealed or confirmed to the advertiser when the user clicks the ad.

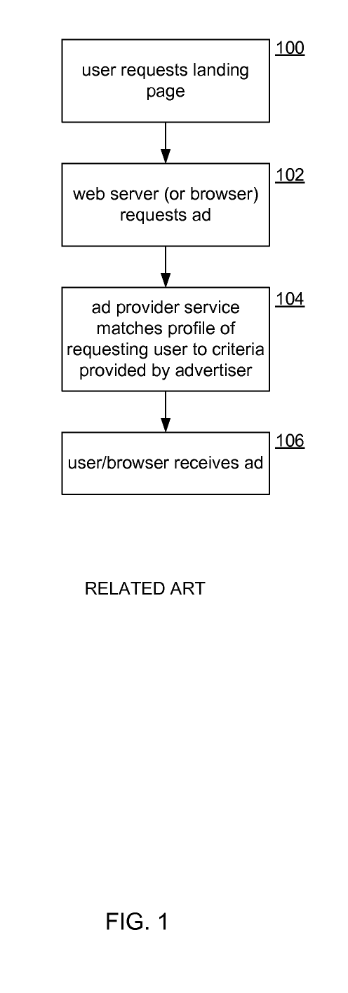

FIG. 1 shows a process describing generally how ads may be served to web browsers. First, a user requests 100 a web page, commonly referred to as a landing page; the page where an ad will be placed. The browser, when rendering the page, encounters a pointer or link to an ad service, and consequently requests 102 an ad from an ad server, ad service, ad network, or the like. The request 102 may be driven by a link or pointer in the landing page to an ad server. There are currently many ways—described elsewhere—by which such a link or pointer may be directly or indirectly provided to a browser; one such way is the use of an HTML iframe element, which indicates that the iframe should be filled with content from the specified link or pointer. The ad service provider then matches 104 a profile associated with the user (in practice web services, including ad services, often treat the browser or computer hosting same as a proxy for the user). The ad service provider may have a database of user profiles and also a set of ad campaigns. Ad criteria, for instance, a set of user behaviors, attributes, characteristics, etc., usually provided by an advertiser, may be associated with each ad campaign. The ad service may match an ad to a user profile by taking the profile associated with the user and finding an ad in a campaign whose ad criteria (e.g., “male”, “video games”) closely match the user's profile. In turn, the browser receives 106 and displays the ad.

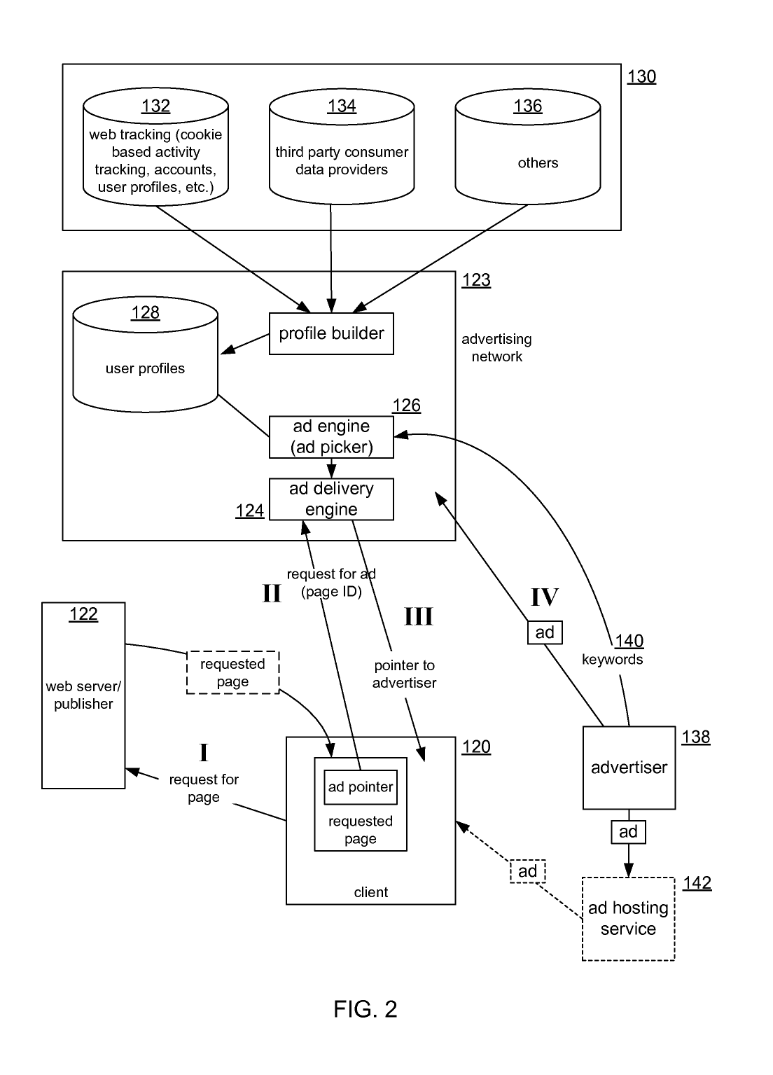

FIG. 2 shows an example ad distribution system. As mentioned above, there are many arrangements and relations between advertisers, content publishers, and other service providers that may lead to an ad being served. FIG. 2 is only an example of one possible such arrangement. Initially, a client 120 running a browser requests (I) a landing page from a web server 122. The requested page is received, and an ad pointer therein causes the browser to (II) request an ad from an ad network or ad provider service 123. The request may include an ID of the landing page and possibly a user ID associated with the user. An ad delivery engine 124 consults ad engine 126, which is a system for selecting ads. The ad engine 126 may consult a database of user profiles 128 to find a profile associated with the user. The ad engine 126 then searches among its current ad campaigns for an ad campaign that has ad selection criteria (keywords, categories, or the like that define categories or types of users to which the ad campaign is targeted) that match the profile associated with the user.

Before continuing with the ad selection and serving process, note that the profiles may have been built using user data 130 such as web tracking data 132, third-party commercial consumer databases 134, and others 136. Profile building is described in detail in other sources. Note also that an ad campaign may involve an advertiser 138 submitting keywords 140 or other forms of data (user attributes, product categories, etc.) that can be compared to user profiles 128 (e.g., NASCAR, beer, baseball, Wichita, University of Somewhere alumni, males, age 20-23, etc.). The ad provider service 123 may maintain such data in association with various different advertisers.

Once an ad campaign or advertiser is selected by the ad engine 126, the browser or client 120 may be directly served an ad by the ad provider service 123, or (III) may be sent a pointer to an ad hosting service 142 that provides the ad. The browser or client 120 then follows the pointer by requesting an ad from the ad hosting service. Again, it should be noted that while variations in the ad-provisioning chain are currently in use, many rely on the basic premise of matching ads to known information about user behavior, user preferences, user traits, and other forms of information about users. Consequently, an ad-matching service has available the user information and ad criteria upon which selection of a given ad was based. Techniques for using this information to safeguard a user will be described next, first in general, and then with reference to an example.

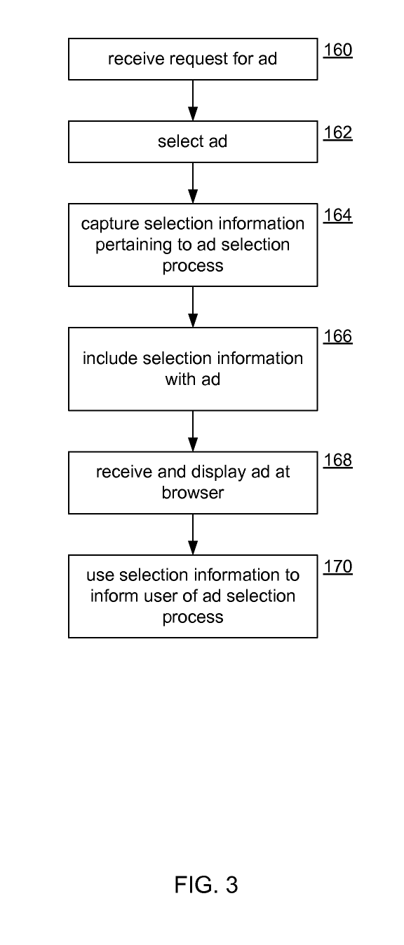

FIG. 3 shows a process by which a user may be provided with information about how an ad was targeted to the user. First, an ad request is received 160. Then, an ad is selected 162 by user targeting as discussed above. Ad-selection criteria—information about how the ad was selected 162—are then captured 164 (e.g., a reference or copy of the information is stored). Such information may include, among others: the fact that user or behavioral-type profiling was used, criteria associated with the ad that led to its selection, or information about the user upon which ad selection was based, etc. In another embodiment, the information may be a subset of these categories, selected from a pre-determined list of categories of information deemed sensitive or susceptible to being combined to personally identify individuals. Some ad serving systems may execute partly or wholly on the client computer hosting the browser, in which case the ad-selection criteria may be captured 164 locally.

The next step is to leverage the ad-selection criteria to help the user avoid unwanted disclosure or affirmation of information. The captured 164 ad-selection criteria or a suitable subset thereof is included 166 with or incorporated into the selected ad or a page that will contain the ad. The ad-selection criteria may take any form such as text, audio data, images, etc. There are numerous known ways to embed such information into an ad or page. For example, an HTML attribute may be used to provide tooltip-like display of the ad-selection criteria. In some older browsers, the “alt” attribute may be used. HTML for modern browsers may use the “title” attribute, which is an attribute of most HTML elements. The “title” attribute causes the text assigned thereto to be displayed when the pointer hovers over the element. In script portions of a web page, other mechanisms may be used. Moreover, scripted embodiments may allow some decision-making to occur before displaying a tooltip. For example, ad providers/networks may choose to include ad-selection criteria with all ads, and browsers may be provided with user settings to control at what threshold or under what circumstances any such criteria should be displayed. Keyword analysis, trained machine-learning models, and various other techniques for analyzing text may be used. When the analysis determines that the ad-selection criteria are to be displayed, the tooltip is activated. Whether conditionally displayed or otherwise, the ad-selection criteria is used 170, via display or as a trigger to other means, to inform the user about the ad selection process, and in some embodiments, to provide opportunity for the user to avoid activating (e.g., clicking) the ad, thereby making ad stalking less likely to succeed.

As mentioned above, an example will now be discussed. To build profiles on users and target ads behaviorally, a user's browser accesses several websites, such as footballfans.org, soccerfans.org, and fitness.org (.org will be omitted for brevity). Each website participates in the AdWorld ad network. The browser is identified to the websites by a cookie used by the ad network, which has a unique identifier, ID:123456. When a server for any of the websites is visited, the server transmits the ID:123456 to a logging server of the ad network, which records each website visited by the ID:123456. Thus, the logging server may have records that ID:123456 visited footballfans, soccerfans, and fitness. A profiling engine analyzes the website visits for ID:123456 (and perhaps other data) to conclude that ID:123456 has attributes or interests such as sports fan, fitness, etc. The profile information may be stored on the server, stored in a cookie if it is small enough, or both.

Given a profile for ID:123456, ads may then be targeted. That is, visitors with this ID to websites participating in the AdWorld ad network may be supplied with ads relevant to the profile for ID:123456. For example, the user/browser/machine associated with ID:123456 visits a landing page in coffeebeans.com, which is in the AdWorld network. Per a link in the landing page, the coffeebeans.com server sends an ad request to an AdWorld ad server with ID:123456. The AdWorld ad server uses ID:123456 to find the associated profile from among other user profiles maintained by AdWorld. Note that AdWorld may not know the actual identity of the user associated with ID:123456. AdWorld is running a campaign for SportsGearInc that is targeted to people interested in fitness. The ad server goes through the keywords associated with various ads or ad campaigns and finds a match between “fitness” in the profile of ID:123456 and “fitness” associated with an ad campaign for SportsGearInc. Having selected an ad or ad campaign, the ad server or ad engine may capture various information involved in the decision to target the ad/advertiser to the user. For instance, the fact that a user profile derived from web-visit tracking was used, the fact that SportsGearInc was the entity responsible for targeting the ad, previously visited web sites used to target the user, all or select identified attributes of the user profile that were used to match the ad/advertiser (e.g., “fitness”), the attributes of the ad or ad campaign that caused it to be matched to the user, and/or others. Moreover, analysis performed on such bases may be used to identify suspect types of information. For example, various types of information alone may trigger capturing such information and passing same to the user. So-called statistically improbable phrases (SIPs) may trigger a capture-and-report response. Or, combinations of attributes may be analyzed in toto to look for and recognize a combination of individually-innocuous attributes that together may define a narrow (perhaps individual-specific) set of users. This may be performed by a trained learning machine, by the recognition of a sufficiently small matching user set, etc. If a tooltip is used, for example, the information in the tooltip may contain, in addition to or instead of the information about the selection criteria, information about the size of the expected matching user set, or some other information or warning indicating to the user that the ad might be suspicious. Moreover, the tooltip information may be shown only if the matching user set size is below a threshold.

When the ad-selection information is captured, the information is added to the SportsGearInc ad (e.g., an ad for running shoes) or to the encompassing page or HTML that is ultimately returned, via the ad server, to the user's browser, where it will be displayed in the landing page. If the ad-selection information—“fitness”—is in the form of a tooltip (e.g., a “title” HTML attribute), then when the user hovers a pointer over the ad, a message is displayed such as “this ad was selected based on your interest in: fitness”.

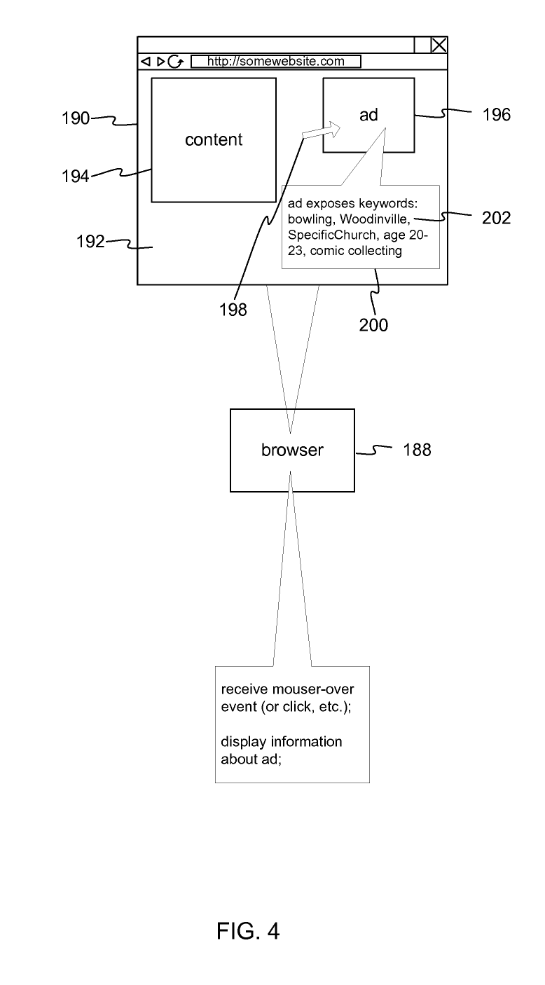

FIG. 4 shows an example of displaying ad selection information. A browser 188 is displaying in browser window 190 a landing page 192 for “somewebsite.com”. The landing page 192 contains content 194 and an ad 196. When the user interacts with the browser 188 and “mouses over” ad 196, that is, manipulates pointer 198 over or near the ad, an event is triggered that causes information to be displayed, in this example, in the form of a tooltip 200. The tooltip 200 contains information about how ad 196 was matched to the user or browser. In the example discussed above, the tooltip 200 might display “fitness” and/or other related information. The example shown in FIG. 4 demonstrates the type of specific information that a user might view with concern. The message text might also inform the user that clicking the ad would reveal this information about the user. In another embodiment, clicking on the ad might display a similar message, with a choice to “cancel” the click or otherwise bypass the ad and prevent communication with a corresponding ad server. In other embodiments, other information that is useful to the user to decide whether or not he or she wants to click may be displayed. For example, the tooltip 200 might display the fact that the ad was deemed to have been selected based on behavioral or targeted advertising, or that the ad was selected based on a statistically improbable phrase, or that activating the ad might reveal information about the user (without reference to that information), or that the ad was selected based on information unrelated to the landing page, and so on.

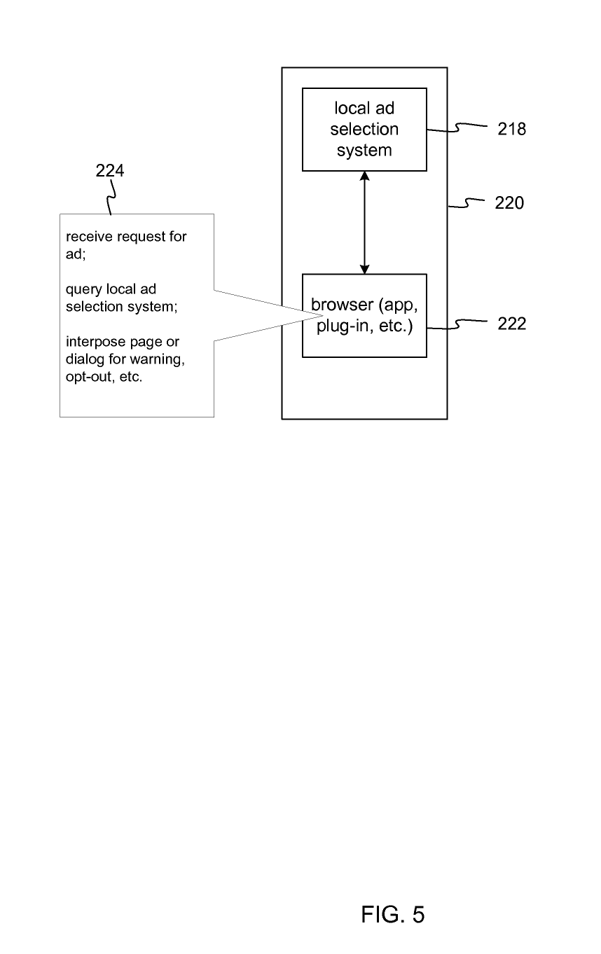

FIG. 5 shows an embodiment involving local ad selection. In this embodiment, all or part of the ad selection process is performed by a local ad selection system 218 locally on the computer 220 or machine hosting the browser 222 (for example a mobile phone or laptop). When an ad is selected or interacted with, the browser, or some other application or module or plug-in, performs a process 224 in which the user is warned and/or given opportunity to avoid the locally selected ad or communication with a server that is linked to the ad.

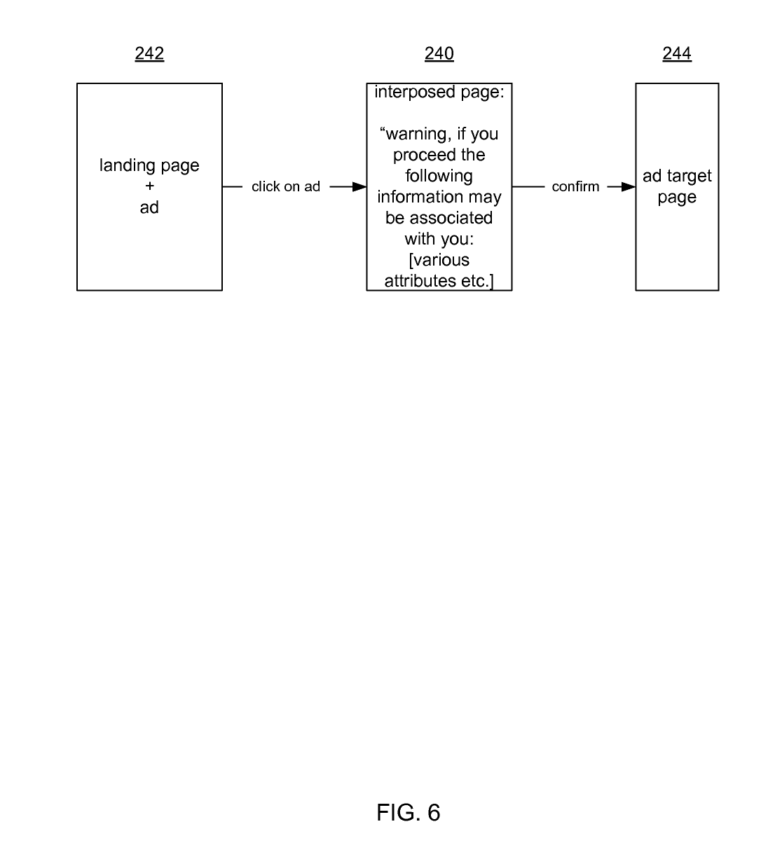

FIG. 6 shows an embodiment in which a web page 240 is used to apprise a user. A landing page 242 with an ad is displayed, requested, interacted with, etc. The web page 240 is displayed, either from a local file or a third party server. An ad target page 244 is displayed only if the user agrees per interaction with the web page 240. If a third party server provides the web page 240, such server may centrally log and accumulate possibly objectionable advertising behavior directed to many users.

### CONCLUSION

Embodiments and features discussed above can be realized in the form of information stored in volatile or non-volatile computer or device readable media. This is deemed to include at least media such as optical storage (e.g., CD-ROM), magnetic media, flash ROM, or any current or future means of storing digital information. The stored information can be in the form of machine executable instructions (e.g., compiled executable binary code), source code, bytecode, or any other information that can be used to enable or configure computing devices to perform the various embodiments discussed above. This is also deemed to include at least volatile memory such as RAM and/or virtual memory storing information such as CPU instructions during execution of a program carrying out an embodiment, as well as non-volatile media storing information that allows a program or executable to be loaded and executed. The embodiments and features can be performed on any type of computing device, including portable devices, workstations, servers, mobile wireless devices, and so on.

1. A method performed by one or more computers to inform a user of advertising information, the method comprising:
receiving a request for an ad, the request having been generated in response to a user request for a landing web page;
selecting an ad based on user information, where the user information is associated with the user and describes behavior and/or attributes and/or preferences associated with the user;
incorporating selection-disclosing information into the ad, the selection-disclosing information comprising information about how the ad was selected, the selection-disclosing information incorporated in the ad in a form that is displayable to the user; and
transmitting the ad with the incorporated selection-disclosing text for display in the landing web page.

2. A method according to claim 1, further comprising displaying the ad at a browser and responding to user interaction with the ad or the landing page by displaying the selection-disclosing text.

3. A method according to claim 2, wherein the user interaction comprises moving a pointer over the ad or clicking the ad.

4. A method according to claim 1, wherein the selecting comprises accessing a database of previously stored user profiles, selecting therefrom a user profile associated with the user, the user information comprising the user profile, and the information about how the ad was selected comprises one or more attributes of the selected user profile.

5. A method according to claim 4, the selecting further comprising matching keywords or categories submitted by an advertising entity that corresponds to the ad, and the selection-disclosing text identifying at least some of the keywords or categories.

6. A method according to claim 5, wherein when the ad is interacted with by the user using the browser, text describing at least some of the keywords or categories is displayed by the browser.

7. One or more computer-readable storage media storing information to enable one or more computers to perform a process, the process comprising:
generating an interactive browser-displayable ad by including therein code that causes a browser to, when the ad is displayed by the browser and interacted with by a user via the browser, display information to the user about how the ad was selected for display to the user.

8. One or more computer-readable storage media according to claim 7, wherein the information describes attributes or behaviors or keywords associated with the user and/or associated with the ad that were used as a basis to match the ad to the user.

9. One or more computer-readable storage media according to claim 7, wherein the ad was selected by matching a user profile corresponding to the user.

10. One or more computer-readable storage media according to claim 9, wherein the user profile comprises attributes or behaviors derived from web tracking data comprised of records of visits of the user to different web pages and linked to the user by a cookie-based user identifier.

11. One or more computer-readable storage media according to claim 7, wherein the source code comprises a text field that corresponds to a property of the ad or of a portion of a page displayed by the browser, the page containing the ad, wherein when the user interacts with the ad displayed in the browser, the text field of the property causes the information indicating how the ad was selected to be displayed by the browser.

12. One or more computer-readable storage media according to claim 7, wherein the generating is performed by an ad generating module on a same computer that is executing the browser.

13. One or more computer-readable storage media according to claim 7, further comprising responding, at the browser, to user interaction with the ad, by displaying a new page in the browser, and performing a click-through of the ad when the user inputs approval via the new web page.

14. One or more computer-readable storage media according to claim 7, wherein information to be displayed comprises a message indicating information about the user that was used to select the ad.

15. A method performed by a computer running a browser, the computer comprised of processor(s) and memory, the method comprising:
executing the browser on the computer;
receiving from a server via a network an ad to be displayed by the browser; and
in response to a user interacting with the ad displayed by the browser, displaying information indicating a basis by which the ad was selected to be displayed to the user.

16. A method according to claim 15, wherein the basis comprises information about the user, and the information displayed comprises text describing the information about the user.

17. A method according to claim 15, further comprising adding the information to the ad by determining whether the basis by which the ad was selected defined a set of users of a size below a threshold.

18. A method according to claim 15, further comprising adding the information to the ad by determining whether the basis by which the ad was selected included predefined user attributes or behaviors.

19. A method according to claim 15, wherein the ad was selected by the accessing of a user profile compiled by linking web sites previously visited by the user, and the user profile was selected by an ad server searching a database of profiles for profiles fitting a profile definition, the basis comprising the profile definition.

20. A method according to claim 19, wherein the information indicating the basis by which the ad was selected is added to the ad based on a decision made by the ad server.
